(19) United States
(12) Patent Application Publication
(10) Pub. No.: US 2004/0029603 A1
(43) Pub. Date: Feb. 12, 2004

(54) Apparatus for implementing a 256-tap matched filter for a user equipment

(76) Inventor: Won-Ho Lee, Suwon-shi (KR)

Correspondence Address: Peter L. Kendall, Roylance, Abrams, Berdo & Goodman, L.L.P., Suite 600, 1300 19th Street, N.W., Washington, DC, 20036, US

(21) Appl. No.: 10/444,113

(22) Filed: May 23, 2003

(30) Foreign Application Priority Data
May 25, 2002 (KR) 2002-29129

(51) Int. Cl. H04B 7/00

(52) U.S. Cl. 455/502; 455/500

(57) ABSTRACT

A cell search apparatus for acquiring synchronization by searching a synchronization channel signal in a mobile communication system. A matched filter matches the synchronization channel signal having a first sequence to a second sequence having a predetermined length. A sequence generator generates a third sequence having a predetermined length according to the second sequence. A multiplexer multiplexes the third sequence so that the third sequence has the same length as the second sequence. A matching value calculator calculates a matching value by the first sequence by using the third sequence and an output value of the matched filter.

### PRIORITY

This application claims priority under 35 U.S.C. § 119 to an application entitled “Apparatus for Implementing 256-Tap Matched Filter for a User Equipment” filed in the Korean Intellectual Property Office on May 25, 2002 and assigned Serial No. 2002-29129, the contents of which are incorporated herein by reference.

### BACKGROUND OF THE INVENTION

1. Field of the Invention

The present invention relates generally to a mobile communication system, and in particular, to an apparatus for implementing a matched filter for use in a synchronization channel searcher of a user equipment (hereinafter referred to as “UE”).

2. Description of the Related Art

In general, a mobile communication system can be roughly classified into a synchronous system and an asynchronous system. The asynchronous system is adopted in Europe, while the synchronous system is adopted in the United States.

Today, with the rapid development of the mobile communication industry, there is a demand for a next generation mobile communication system which supports data and image services as well as voice service. Standardization of such a system is now under way. However, since the United State and Europe, as mentioned above, adopt different mobile communication systems, standardizations are also being conducted separately. Of the next generation mobile communication systems, the European mobile communication system is called “UMTS (Universal Mobile Telecommunications System).”

The UMTS system, since it adopts the asynchronous system, requires acquiring synchronization with a particular Node B, or cell, over a predetermined synchronization channel. That is, a cell search operation is required.

Of downlink physical channels (hereinafter referred to as DPCH”) for the UMTS system, a primary synchronization channel (hereinafter referred to as “P-SCH”) and a secondary synchronization channel (hereinafter referred to as “S-SCH”) are used for cell search. Of the two channels used for the cell search, the P-SCH is a channel over which a sequence with a length of 256 chips is repeatedly transmitted for the first 256 chips of each slot (1 slot=2560 chips). In a UE of the UMTS system, slot timing synchronization is acquired using the P-SCH.

Generally, a method of demodulating a pilot signal for cell search can be divided into a first method using a matched filter and a second method using a correlator. Of the two methods, the method using a matched filter is advantageous in that a time required for cell search is short, but the method is disadvantageous in that its complexity is high when it is realized by hardware. Meanwhile, the method using a correlator has the opposite characteristics of the method using a matched filter. That is, the demodulation method using the correlator is disadvantageous in that a time required for cell search is long, but the method is advantageous in that its hardware complexity is low.

FIG. 1 is a diagram illustrating an example of a 256-tap matched filter used for a synchronization channel searcher of a UE according to the prior art. Referring to FIG. 1, a UE uses a matched filter that is matched to a sequence with a 256-chip length used for a synchronization channel, for a cell search. In the UMTS system, one slot length is 2560 chips. Thus, when the matched filter of FIG. 1 is used, if a signal-to-noise ratio (hereinafter referred to as “SNR”) is high, slot timing synchronization can be acquired for a maximum of 2560 chips, or one slot.

A c-sequence used for the synchronization channel is a sequence with a 256-chip length, and is given by

$${z}_{256} ( n ) = {\sum }_{k = 0}^{255} {c}_{k}^{′} \cdot x ( n - k ) \qquad Equation ( 2 )$$

That is, since the c-sequence used for the synchronization channel has a length of 256 chips, the matched filter has 256 taps. If an input signal of the matched filter matched to the c-sequence for the synchronization channel is defined as x(n), an output signal Z₂₅₆(n) of the matched filter is represented by

$$\begin{matrix}c = < {c}_{0} , {c}_{1} , {c}_{2} , … , {c}_{255} > \\ = < a , a , a , \overline{a} , \overline{a} , a , \overline{a} , \overline{a} , a , a , a , \overline{a} , a , \overline{a} , a , a >\end{matrix} \qquad Equation ( 1 )$$

In Equation (2), c′ₖ (k=0,1,2, . . . , 255) indicates a tap coefficient of the matched filter, and is given by

c′ₖ=c₂₅₅₋ₖfor k=0,1,2, . . . , 255 Equation (3)

That is, as shown in Equation (3), the tap coefficient of the matched filter is determined by arranging sequences in an opposite order for a transmission signal. Herein, the c′ₖ (k=0,1,2, . . . , 255) is referred to as “c′-sequence.”

That is, 255 delay elements 110-1 to 110-255, 256 multipliers 120-1 to 120-256, and 255 adders 130-1 to 130-255 are used in order to realize the 256-tap matched filter. That is, the UE applies an input signal comprised of an in-phase channel (or I-channel) and a quadrature-phase channel (or Q-channel) to a 256-chip matched filter, for a cell search. Accordingly, when the 256-tap matched filter is implemented by hardware, its complexity is high.

However, in Equation (1), ‘a’ is a sequence with a length of 16 chips, and is given by

$$\begin{matrix}a - < {a}_{0} , {a}_{1} , {a}_{2} , … , {a}_{15} > \\ - < ∣ 1 , ∣ 1 , ∣ 1 , ∣ 1 , ∣ 1 , ∣ 1 , - 1 , - 1 , ∣ 1 , - 1 , ∣ 1 , - 1 , ∣ 1 , - 1 , - 1 , ∣ 1 >\end{matrix} \qquad Equation ( 4 )$$

where \overline{a} indicates a sequence determined by multiplying ‘a’ by −1.

From Equation (1) to Equation (3), a c-sequence with a 256-chip length used for the synchronization channel is equivalent to a sequence obtained by repeating an a-sequence with a 16-chip length 16 times by changing only a sign. In other words, an output Zᵢ(n) of the 256-tap matched filter is equivalent to a value determined by multiplying an (n+16×k)^{th} output (k=0,1 , . . . , 15) of a matched filter matched to an a-sequence by y(0), y(1), . . . , y(15). As a result, 16 consecutive outputs of the 256-tap matched filter can be obtained using 256 consecutive outputs of a 16-tap matched filter. That is, it can be understood that the 16 outputs can be obtained by receiving a sequence used for the synchronization channel having a 256-chip length. Thus, there is a demand for an apparatus for realizing a 256-tap matched filter by using a 16-tap matched filter.

### SUMMARY OF THE INVENTION

It is, therefore, an object of the present invention to provide an apparatus for implementing a low-complexity matched filter for a synchronization channel searcher of a user equipment (UE).

It is another object of the present invention to provide an apparatus for realizing a 256-tap matched filter by using a 16-tap matched filter.

To achieve the above and other objects, there is provided a cell search apparatus for acquiring synchronization by searching a synchronization channel signal in a mobile communication system. A matched filter matches the synchronization channel signal having a first sequence to a second sequence having a predetermined length. A sequence generator generates a third sequence having a predetermined length according to the second sequence. A multiplexer multiplexes the third sequence so that the third sequence has the same length as the second sequence. A matching value calculator calculates a matching value by the first sequence by using the third sequence and an output value of the matched filter.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating an example of a 256-tap matched filter used for a synchronization channel searcher of a UE according to the prior art;

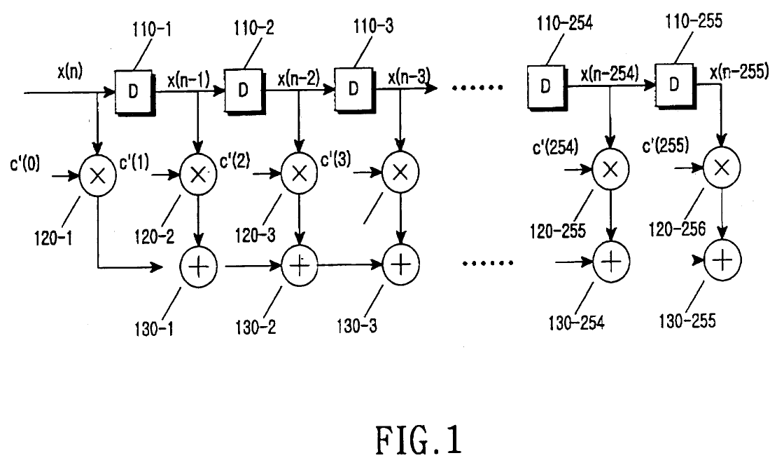

FIG. 2 is a block diagram illustrating an example of a 256-tap matched filter implemented using a 16-tap matched filter according to an embodiment of the present invention;

FIG. 3 is a timing diagram illustrating an example of a timing relationship among an H signal, an M signal and an L signal, provided from the counter illustrated in FIG. 2 according to an embodiment of the present invention; and

FIG. 4 is a block diagram illustrating an example of a structure of the y′-sequence generator illustrated in FIG. 2 according to an embodiment of the present invention.

### DETAILED DESCRIPTION OF THE PREFERRED EMBODIMENT

Several embodiments of the present invention will now be described in detail with reference to the accompanying drawings. In the drawings, the same or similar elements are denoted by the same reference numerals. In the following description, a detailed description of known functions and configurations have been omitted for conciseness.

The present invention is based on a c-sequence with a 256-chip length used for a synchronization channel being equivalent to a sequence obtained by repeating an a-sequence with a 16-chip length 16 times by changing only a sign. That is, the present invention provides a method for realizing a 256-tap matched filter for a c-sequence by using a 16-tap matched filter for an a-sequence.

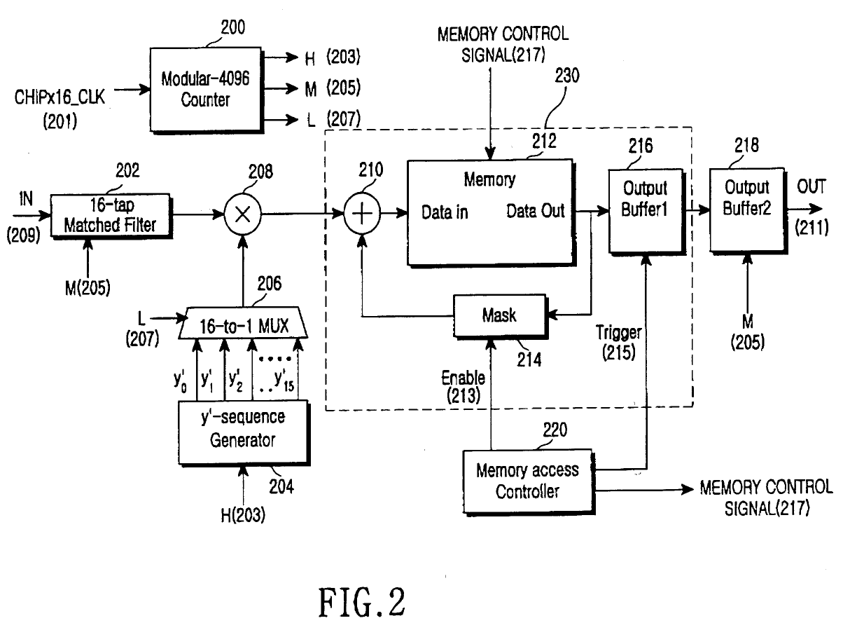

FIG. 2 is a block diagram illustrating an example of a 256-tap matched filter implemented using a 16-tap matched filter according to an embodiment of the present invention. Referring to FIG. 2, a 256-tap matched filter includes a modulo-4096 counter 200, a 16-tap matched-filter 202, a y′-sequence generator 204, a 16-to-1 multiplexer 206, a multiplier 208, an adder 210, a memory 212, a mask 214, a first output buffer 216, a second output buffer 218, and a memory access controller 220.

A description will now be made of the modulo-4096 counter 200. The modulo-4096 counter 200 (hereinafter referred to as “counter” for short) is driven with a clock CHIP*16_CLK (201) having a rate which is 16 times the chip rate (=3.84 Mcps), and is increased from 0 to 4095. Since 4096/16=256, a cycle of the counter 200 is 256 chips. An output of the counter 200 is comprised of 12 bits, and of the 12 bits, higher 4 bits are called a high (H) signal 203, 4 intermediate bits are called a middle (M) signal 205, and lower 4 bits are called a low (L) signal 207. The H signal 203 increases by 1 every 16 chips, the M signal 205 increases by 1 every chip, and the L signal 207 increases by 1 every 1/16 chip. That is, the counter 200 outputs the L signal 207 having a rate 1/16 times the chip rate, the M signal 205 having the chip rate, and the H signal 203 having a rate 16 times the chip rate by receiving a clock signal CHIP×16_CLK (201) having a rate 16 times the chip rate. The H signal 203, the M signal 205 and the L signal 207 output from the counter 200 are provided to the 16-tap matched filter 202, the 16-to-1 multiplexer 206 (hereinafter referred to as “multiplexer” for short), the second output buffer 218, and the memory access controller 220.

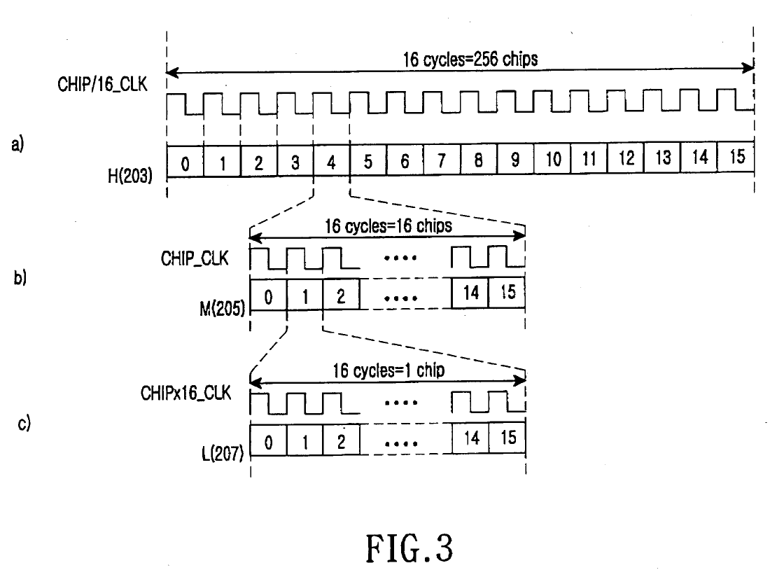

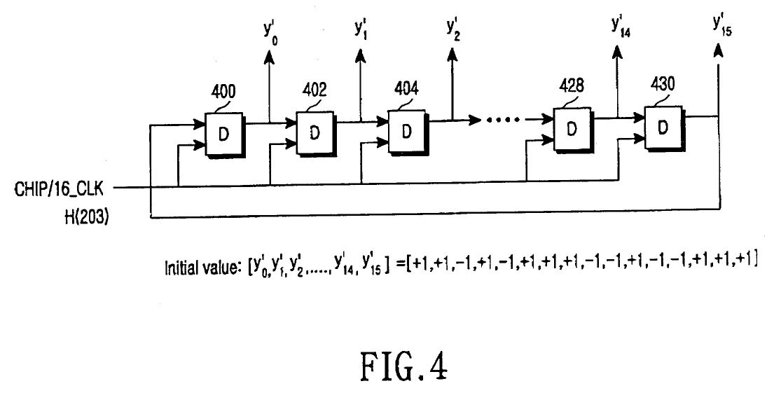

FIG. 3 is a timing diagram illustrating an example of a timing relationship among the H signal 203, the M signal 205 and the L signal 207 output from the counter 200 of FIG. 2 according to an embodiment of the present invention. Referring to FIG. 3, of the output signals of the counter 200, the H signal 203 has a value of CHIP/16_CLK, the M signal 205 has a value of CHIP_CLK, and the L signal 207 has a value of CHIP*16_CLK. That is, the H signal 203 increases by 1 every 16 chips, the M signal 205 increases by 1 every chip, and the L signal 207 increases by 1 every 1/16 chip. Next, a description will be made of the y′-sequence generator 204 with reference to FIG. 4.

FIG. 4 is a block diagram illustrating an example of a structure of the y′-sequence generator 204 illustrated in FIG. 2 according to an embodiment of the present invention. Referring to FIG. 4, the y′-sequence generator 204 has 16 delay elements 400 to 430 connected on a circulation basis. The y′-sequence generator 204 provides 16 output signals y′_{—}0 to y′_{—}15 to the multiplexer 206, and operates using the H signal 203 as a clock. Since the number of the delay elements 400 to 430 constituting the y′-sequence generator 204 is 16 and shift occurs every 16 chips, 256 chips are required when values stored in the delay elements 400 to 430 are circulated one round to their original places.

An operation of a 256-tap matched filter realized using a 16-tap matched filter according to an embodiment of the present invention will now be described with reference to FIGS. 2 and 4. The 16-tap matched filter 202 of FIG. 2 is a matched filter that is matched to an a-sequence. The 16-tap matched filter 202 operates by receiving the M signal 205 among the clock signals output from the counter 200. The multiplexer 206 selects a particular signal from a plurality input signals. In particular, the 16-to-1 multiplexer 206, used in the present invention, selects one signal out of 16 input signals. That is, since the multiplexer 206 is a 16-to-1 multiplexer, it selects one signal out of 16 signals provided from the y′-sequence generator 204. The multiplexer 206 operates by using the L signal 207 as a control signal. The multiplier 208 multiplies an output signal of the 16-tap matched filter 202 by an output signal of the multiplexer 206, and provides its output to the adder 210. The adder 210 adds an output signal of the multiplier 208 and an output signal of the mask 214, and provides its output to the memory 212. The memory 212 has 256 addresses. Commonly, the memory 212 can be designed to have addresses of 0 to 255. However, the memory 212 is not limited by the addresses.

The mask 214 receives a data output signal of the memory 212 and operates in accordance with Equation (5) below.

$$Output of Mask - \{ \begin{matrix}Data output of 256 - Memory & if Enable - 1 \\ 0 & if Enable - 0\end{matrix} \qquad Equation ( 5 )$$

In Equation (5), “Enable” is a signal generated by the memory access controller 220, and the mask 214 operates in response to the enable signal. For example, the mask 214 provides a data output signal received from the memory 212 to the adder 210 when an enable signal 213 received from the memory access controller 220 has a value “1.” In contrast, when the enable signal 213 received from the memory access controller 220 has a value “0,” the mask 214 provides a value “0” to the adder 210. The first output buffer 216 provides the second output buffer 218 with only the signals selected by a trigger signal 215 among the data output signals of the memory 212. The trigger signal 215 is generated by the memory access controller 220. The first output buffer 216 can be realized using a flip-flop. The second output buffer 218 samples a data output signal of the memory 212 which was selected by the trigger signal 215, and received from the first output buffer 216, at a chip rate. The second output buffer 218 performs sampling in response to the M signal 205, a clock signal having a chip rate.

The memory access controller 220 performs operations of (i) generating the enable signal 213 applied to the mask 214, (ii) generating the trigger signal 215 applied to the first output buffer 216, and (iii) controlling a read/write operation of the memory 212.

In the following description, it will be proved using formulas that a 256-tap matched filter can be implemented using the 16-tap matched filter 202.

The 16-tap matched filter 202 of FIG. 2 is a filter matched to an a-sequence, described in conjunction with Equation (4), and if an input of the matched filter 202 is defined as x(n), then its output Z₁₆(n) becomes

$${z}_{16} ( n ) = {\sum }_{k = 0}^{15} x ( n - k ) \cdot {a}_{k}^{′} \qquad Equation ( 6 )$$

In Equation (6), a′ₖ (k=0,1,2, . . . , 15) is a tap coefficient of the 16-tap matched filter 202, and is given by

a′ₖ=a_{15-k =0,1,2, . . . , 15} Equation (7)

That is, like the c′-sequence represented by Equation (3), the a′-sequence is determined by arranging a c-sequence and an a-sequence in the opposite order, so the c′-sequence is equivalent to a sequence obtained by repeating the a′-sequence by changing only a sign. This can be expressed by

$$\begin{matrix}{c}^{′} = < {c}_{0}^{′} , {c}_{1}^{′} , {c}_{2}^{′} , … , {c}_{255}^{′} > \\ - < {a}^{′} , {a}^{′} , {\overline{a}}^{′} , {a}^{′} , {\overline{a}}^{′} , {a}^{′} , {a}^{′} , {a}^{′} , {\overline{a}}^{′} , {\overline{a}}^{′} , {a}^{′} , {\overline{a}}^{′} , {\overline{a}}^{′} , {a}^{′} , {a}^{′} , {a}^{′} >\end{matrix} \qquad Equation ( 8 )$$

In Equation (8), a code pattern with repeated ‘a's of Equation (1) is arranged in the opposite order. From Equation (8), an output Z₂₅₆(n) of a 256-tap matched filter is expressed by Equation (9) below by using output signals of the 16-tap matched filter 202 matched to an a-sequence.

$${z}_{256} ( n ) = {\sum }_{i = 0}^{15 {z}_{16}} ( n - 16 i ) \cdot {y}_{i}^{′} \qquad Equation ( 9 )$$

Here, the y′-sequence is obtained by replacing a′ of Equation (8) with +1 and \overline{a′} with −1, and becomes

$$\begin{matrix}{y}^{′} - < {y}_{0}^{′} , {y}_{1}^{′} , {y}_{2}^{′} , … , {y}_{15}^{′} > \\ - < ∣ 1 , ∣ 1 , - 1 , ∣ 1 , - 1 , ∣ 1 , ∣ 1 , - 1 , - 1 , ∣ 1 , ∣ 1 , - 1 , - 1 , ∣ 1 , ∣ 1 , ∣ 1 >\end{matrix} \qquad Equation ( 10 )$$

Meanwhile, from Equation (9), Z₂₅₆(n−16) is given by

$${z}_{256} ( n - 16 ) - {\sum }_{i = 0}^{15} {z}_{16} ( n - 16 ( i + 1 ) ) \cdot {y}_{i}^{′} - {\sum }_{i = 1}^{16} {z}_{16} ( n - 16 i ) \cdot {y}_{( i - 1 ) mod16}^{′} \qquad Equation ( 11 )$$

Comparing Equation (9) with Equation (11), it is noted that values Z₁₆(n+16i) (i=1,2, . . . , 15) are all used for calculation of Z₂₅₆(n) and Z₂₅₆(n−16), and only the y′-sequence applied thereto is circular-shifted. While Z₁₆(n−16i) is multiplied by y′₁ in Equation (9), Z₁₆(n−16i) is multiplied by y′_{(i-1)mod16} in Equation (11). If normalized, Equation (11) becomes

$${z}_{256} ( n - 16 k ) - {\sum }_{j = o}^{15} {z}_{16} ( n - 16 ( k ∣ 1 ) \backslash \cdot {y}_{i}^{′} - {\sum }_{j = k}^{k + 15} {z}_{16} ( n - 16 i ) \cdot {y}_{( i - k ) mod16}^{′} \qquad Equation ( 12 )$$

It is noted from Equation (12) that it is possible to determine values obtained by sampling Z₂₅₆(n−16k) (where k is an integer), i.e., an output of a 256-tap matched filter every 16 chips, by using the values obtained by sampling an output of the 16-tap matched filter 202 every 16 chips.

In addition, by determining a formula for calculating Z₂₅₆(n−16(k−1)), Z₂₅₆(n−16(k−2)), . . . , Z₂₅₆(n−16(k−15)) using Equation (12), it is noted that Z₁₆(n−16k) is used for all the outputs. That is, one output of the 16-tap matched filter 202 is multiplied by y′ᵢ (i=0,1,2, . . . , 15) and then, used in determining 16 outputs of the 256-tap matched filter. Herein, 16 outputs of the 256-tap matched filter are separated from one another by 16 chips.

A method for determining outputs Z₂₅₆(n−16k) (where k is an integer), separated by 16 chips, among the outputs of the 256-tap matched filter has been described so far. Next, a description will be made of a method for determining 16 consecutive outputs of the 256-tap matched filter, from Equation (12). If ‘n’ in Equation (12) is substituted by (n−j), then Equation (13) below can be obtained.

$${z}_{256} ( n - 16 k - j ) - {\sum }_{i = k}^{k + 15} {z}_{16} ( n - 16 i - j ) \cdot {y}_{( i - k ) mod16}^{′} \qquad Equation ( 13 )$$

In Equation (13), 0≦j≦15. From Equation (13), the following can be noted. First, Z₂₅₆(n−16k−j) can be calculated using the y′-sequence that was used when calculating Z₂₅₆(n−16k). Second, outputs of the 16-tap matched filter 202, used when calculating Z₂₅₆(n−16k−j), are outputs at a time separated by j chips (0≦j≦15) as compared with the outputs of the 16-tap matched filter 202, used when calculating Z₂₅₆(n−16k). A method for calculating outputs separated by 16 chips among the outputs of the 256-tap matched filter and further calculating outputs separated by j chips therefrom has been described so far. In this method, it is possible to calculate all outputs of the 256-tap matched filter. That is, output values of the 256-tap matched filters can be calculated by using output values of the 16-tap matched filter 202.

Referring to FIG. 2, the 16-tap matched filter 202 is a matched filter that is matched to an a-sequence, and performs calculation of Equation (6). An input signal 209 of the 16-tap matched filter 202 becomes an input signal of the 256-tap matched filter realized in the present invention, and this corresponds to an input signal x(n) of the 256-tap matched filter. The y′-sequence generator 204 outputs y′ₖ (k=0,1,2, . . . , 15) of Equation (9) to Equation (12). Output signals of the y′-sequence generator 204 applied to the multiplexer 206. The multiplexer 206 sequentially outputs y′₀, y′₁, . . . , y′₁₅ for one chip, since it operates by using the L signal 207 for counting a signal 16 times for one chip as a clock signal. Therefore, the multiplier 208 multiplies an output of the 16-tap matched filter 202 by the outputs y′₀, y′₁, . . . , y′₁₅ of the multiplexer 206, thereby performing multiplication 16 times for one chip. The adder 210 also performs addition 16 times for one chip. By doing so, calculation of Equation (12) is implemented. In this implementation, one output signal of the 16-tap matched filter 202 is multiplied by y′ₘ (m=0,1,2, . . . , 15) and then, used in calculating 16 outputs separated by 16 chips among outputs of the 256-tap matched filter. As described above, since output signals of the 16-tap matched filter are multiplied by the y′ₘ (m=0,1,2, . . . , 15), 256 output signals of the 16-tap matched filter 202 are multiplied by the y′ₘ (m=0,1,2, . . . , 15), thereby performing multiplication a total of (256×16) times for 256 chips (i.e., for a time when the H signal is counted from 0 to 15).

The memory access controller 220 controls a process of calculating 256 outputs of the 256-tap matched filter by using (256×16) outputs provided from the multiplier 208, for 256 chips. One output of the 256-tap matched filter can be calculated by adding the 16 outputs of the 16-tap matched filter 202. A control operation of the memory access controller 220 will be described herein below. The memory access controller 220 performs the following operations on the L signal 207 for a time when the L signal 207 is increased from 0 to 15, for each chip.

(1) Contents of an address M+16*L are read from the memory 212, and he read value is called SUM_{L}.

(2) It is determined whether a count value of the L signal 207 is identical to a count value of the H signal 203.

(3) If the count values of the L signal 207 and the H signal 203 are identical to each other, the SUM_{L} value is updated in accordance with Equation (14) below.

SUM_{L}=SUM_{L}+Ouptut Signal Value of Multiplier (208) Equation (14)

(4) If the count values of the L signal 207 and the H signal 203 are identical to each other, the SUM_{L} is stored in the first output buffer 216, and then updated in accordance with Equation (15) below.

SUM_{L}=Output Signal Value of Multiplier (208) Equation (15)

(5) The updated SUM_{L} value is stored in an address M+16*L of the memory 121.

As described above, since 16 read operations and 16 write operations for the memory 212 are required every chip, it is preferable, in an embodiment of the present invention, to implement the memory 212 with a synchronous dual-port RAM, considering memory access speed. Meanwhile, as described in conjunction with the processes (3) and (4), a method of updating the contents stored in the memory 212 is different according to an M value. In the embodiment, this is realized using the mask block 214. That is, when the L signal 207 and the H signal 203 are identical, the enable signal 213 applied to the mask 214 is set to “0.” If the L signal 207 and the H signal 203 are not identical, the enable signal 213 is set to “1.” As a result, if the L signal 207 and the H signal 203 are identical, an output signal of the memory 212 is not provided to the adder 210. In this case, the adder 210 adds only the output of the multiplier 208. The enable signal 213 is generated from the memory access controller 213.

In addition, when the L signal 207 and the H signal 203 are identical in the process (3), output data of the memory 212 is stored in the first output buffer 216. Thus, the trigger signal 215 applied to the first output buffer 216 is generated when the L signal 207 is identical to the H signal 203 (L==H). Since a value of the L signal 207 is increased from 0 to 15 for one chip, a period (or duration) satisfying the condition of (L==M) necessarily exists once for each chip, and a length of this period is 1/16 chip. Therefore, the first output buffer 216 outputs a new value once every chip. However, a location of the period satisfying the condition (L=H) within a one-chip time is changed according to a value of the H signal 203. Therefore, a time when the first output buffer 216 outputs a signal is also changed. The second output buffer 218 samples an irregular output of the first output buffer 216 at a chip rate, thereby outputting a final output signal of the 256-tap matched filter at a constant rate of the chip rate.

The invention, as described above, can realize a 256-tap matched filter by using the 16-tap matched filter 202. Since the 16-tap matched filter 202 can be realized using 16 adders and 16 multipliers, the invention can realize a compact 256-tap matched filter. In addition, since the elements in FIG. 2 except for the 16-tap matched filter 202 and the memory 212 have a low hardware complexity, an influence of these elements on the whole hardware complexity of the system is insignificant. Furthermore, when several 256-tap matched filters realized by using the 16-tap matched filter 202 are used, the counter 200, the y′-sequence generator 204, the multiplexer 206 and the memory access controller 220 can be shared, thereby contributing to a reduction in hardware complexity and size. For example, since a synchronization channel searcher of a UE needs a 256-tap matched filter for each of an I-channel and a Q-channel, it requires at least two 256-tap matched filters. Generally, since a synchronization channel searcher requires on-time and late-time searchers in order to perform a search by the ½ chip, the total number of 256-tap matched filters required by the synchronization channel searcher is 4. As stated above, since the counter 200, the y′-sequence generator 204, the multiplexer 206 and the memory access controller 220 can be shared by the 4 256-tap matched filters, the hardware size is reduced when implementing a plurality of 256-tap matched filters.

Although the invention has been shown and described with reference to a 256-tap matched filter used in a synchronization channel searcher of a UE, this is not to restrict the invention but to bring a better understanding of the invention. Therefore, those skilled in the art can appreciate that a tap other than a 256-tap can be used without departing from the scope of the present invention. In addition, the invention can extend its application to a long-length sequence by repeating a short-length sequence. That is, in a method described in conjunction with the embodiment, a matched filter for a long-length sequence can be realized by using a matched filter for a short-length sequence.

As described above, the invention can realize a 256-tap matched filter by using a 16-tap matched filter that requires a small number of elements, thereby contributing to a reduction in size of the 256-tap matched filter.

While the invention has been shown and described with reference to a certain embodiment thereof, it will be understood by those skilled in the art that various changes in form and details may be made therein without departing from the spirit and scope of the invention as defined by the appended claims.

What is claimed is:

1. A cell search apparatus for acquiring synchronization by searching a synchronization channel signal in a mobile communication system, comprising:
a matched filter for matching the synchronization channel signal having a first sequence to a second sequence having a predetermined length;
a sequence generator for generating a third sequence having a predetermined length according to the second sequence;
a multiplexer for multiplexing the third sequence so that the third sequence has the same length as the second sequence; and
a matching value calculator for calculating a matching value by the first sequence by using the third sequence and an output value of the matched filter.

2. The cell search apparatus of claim 1, wherein the matching value calculator comprises:
a multiplier for multiplying an output of the matched filter by the third sequence output from the multiplexer;
an adder for adding an output of the multiplier to a feedback value from a memory; and
a memory section for storing an output of the adder in the memory, and outputting a matching value for the first sequence by repeating for a predetermined period an operation of feeding back the value stored in the memory to the adder so as to add the stored value to an output of the multiplier.

3. The cell search apparatus of claim 1, wherein the first sequence used for the synchronization channel signal has a length of 256 chips, and the second sequence has a length of 16 chips.

4. The cell search apparatus of claim 3, further comprising a counter for providing the matched filter with a clock having a chip rate, the sequence generator with a clock having a rate 1/16 times the chip rate, and the multiplexer with a clock having a rate 16 times the chip rate.

5. The cell search apparatus of claim 2, further comprising a memory access controller for generating control signals so that the memory section reads or writes an output of the adder according to a clock having a rate 16 times a chip rate, and applying the generated control signals to the memory section.

6. The cell search apparatus of claim 1, wherein the second sequence is defined as a particular sequence among sequences generated by equally dividing the first sequence by 16 chips.

7. The cell search apparatus of claim 5, wherein the second sequence is +1, +1, +1, +1, +1, +1, −1, −1, +1, −1, +1, −1, +1, −1, −1, +1.

8. The cell search apparatus of claim 7, wherein the third sequence is obtained by arranging 16 number of values mapped with +1 or −1 according to relation between the sequences generated by equally dividing the first sequence by 16 chips in the opposite order arrangement of a sequence generated.

9. The cell search apparatus of claim 6, wherein the third sequence is +1, +1, −1, +1, −1, +1, +1, +1, −1, −1, +1, −1, −1, +1, +1, +1.

10. The cell search apparatus of claim 4, wherein the matched filter multiplies the synchronization channel signal by respective chips constituting the second sequence, and adding the multiplication results.

11. The cell search apparatus of claim 10, wherein the memory have addresses as many as the number of chips of the first sequence and outputs the stored value, a data signal by the 1/16 chip.

12. The cell search apparatus of claim 11, wherein the memory section performs a read/write operation by the 1/16 chip according to a control signal provided from the memory access controller.

13. The cell search apparatus of claim 1, wherein the multiplexer includes 16 delay elements connected on a circulation basis so that the sequence generator outputs 16 signals for each chip according to a clock signal provided from the counter.

14. The cell search apparatus of claim 2, wherein the adder feeds back said data signal output from the memory section via a mask according to an enable signal provided from the memory access controller.

15. The cell search apparatus of claim 14, wherein the mask provides the adder with said data signal output from the memory section when the enable signal has a value of “1,” and provides the adder with only an output signal of the multiplier when the enable signal has a value of “0.”

16. The cell search apparatus of claim 15, further comprising:
a first output buffer for receiving said data signals output from the memory section, and selecting said data signals according to a trigger signal provided from the memory access controller; and
a second output buffer for performing sampling so that signals output from the first output buffer should be outputted at stated intervals.

17. The cell search apparatus of claim 16, wherein the memory access controller applies the trigger signal to the memory section to output said data signal as a matching value for the first sequence when a clock having a rate 16 times the chip rate is identical to a count value of a clock having a rate 1/16 times the chip rate.

18. An apparatus realizing a 256-tap matched filter for acquiring synchronization by searching a synchronization channel signal in a mobile communication system, comprising:
a counter for receiving a clock signal increasing by 1 per 1/16 chip, and outputting a high signal increasing by 1 per 16 chips, a middle signal increasing by 1 per chip, and a low signal increasing by 16 per chip;
a 16-tap matched filter for receiving the synchronization channel signal spread by the first sequence, and outputting a 16-tap signal every chip according to the middle signal provided from the counter;
a sequence generator for outputting a sequence for changing a sign of output signals of the 16-tap matched filter according to the high signal provided from the counter;
a multiplexer for outputting 16 sequences for a sequence output form the sequence generator according to the low signal provided from the counter;
a multiplier for multiplying the 16-tap signal output from the 16-tap matched filter by the 16 sequences output from the multiplexer;
an adder for adding an output signal of the multiplier and a data signal fed back from a memory section;
a first output buffer for outputting only a data signal selected from data signals output from the memory section in response to a trigger signal provided from a memory access controller;
a second output buffer for performing sampling so as to output signals from the first output buffer at stated intervals; and
the memory access controller for providing the memory section with control signals so that the memory section reads or writes a data signal output from the memory and an output signal of the multiplier.

19. A cell search method for acquiring synchronization by searching a synchronization channel signal in a mobile communication system, steps of:
matching the synchronization channel signal having a first sequence to a second sequence having a predetermined length and outputting a matched value by said predetermined length;
multiplying said matched value by each chip of a third sequence having a predetermined length sequentially and outputting a multiplied value by every chip;
adding said multiplied value to a feedback value from a memory section and outputting a added value to said memory section; and
outputting a data signal as a matched value for said first sequence.

20. The cell search method of claim 19, wherein the first sequence used for the synchronization channel signal has a length of 256 chips, and the second sequence has a length of 16 chips.

21. The cell search method of claim 19, if a clock having a rate 16 times the chip rate is identical to a count value of a clock having a rate 1/16 times the chip rate, and said data signal is output.

22. The cell search method of claim 20, wherein the second sequence is defined as a particular sequence among sequences generated by equally dividing the first sequence by 16 chips.

23. The cell search method of claim 22, wherein the second sequence is +1, +1, +1, +1, +1, +1, −1, −1, +1, −1, +1, −1, +1, −1, −1, +1.

24. The cell search method of claim 20, wherein the third sequence is obtained by arranging 16 number of values mapped with +1 or −1 according to relation between the sequences generated by equally dividing the first sequence by 16 chips in the opposite order arrangement of a sequence generated.

25. The cell search method of claim 24, wherein the third sequence is +1, +1, −1, +1, −1, +1, +1, +1, −1, −1, +1, −1, −1, +1, +1, +1.

26. The cell search method of claim 19, further comprising a counter for providing the matched filter with a clock having a chip rate, the sequence generator with a clock having a rate 1/16 times the chip rate, and the multiplexer with a clock having a rate 16 times the chip rate.
